(19) United States
(12) Patent Application Publication
(10) Pub. No.: US 2007/0136671 A1
(43) Pub. Date: Jun. 14, 2007

(54) Method and system for directing attention during a conversation

(76) Inventor: Eric R. Buhrke, Clarendon Hills, IL (US)

Correspondence Address: MOTOROLA, INC., 1303 EAST ALGONQUIN ROAD, IL01/3RD, SCHAUMBURG, IL, 60196, US

(21) Appl. No.: 11/299,880

(22) Filed: Dec. 12, 2005

(51) Int. Cl. G06F 9/00; G06F 17/00

(52) U.S. Cl. 715/751; 715/733; 715/757; 715/848

(57) ABSTRACT

A method and a system for directing attention during a conversation in virtual space are provided. The method includes receiving (402) the data streams from a plurality of participants and processing (404) at least one feature of each of the data streams. The method further includes altering (406) a representation of one of the plurality of participants, based on at least one feature of one of the data streams.

### FIELD OF THE INVENTION

The present invention relates to the field of conversational dynamics, and more specifically, to directing attention in a conversation in virtual space.

### BACKGROUND OF THE INVENTION

In a face-to face-conversation, conversational dynamics such as body language, the pitch of the voice, the intensity of voice, gestures, and so forth, play an important role in making the conversation lively. These conversational dynamics are used by a participant in a conversation, particularly a conversation in which more than two persons participate, to attract the attention of other participants.

In a conversation carried in virtual space, participants may be present in different geographical locations, and hence, may not be able to see each other. They may interact through a network, and hence, may not be able to visualize the body language and gestures of the participants. Examples of a conversation in virtual space include telephonic conversations, video conferencing, online conversations though the Internet, and mobile conversation.

The non-availability of conversational dynamics reduces the conversational experience in virtual space. A participant may not get the required attention while speaking, due to the lack of conversational dynamics. This may make the conversation less interesting and degrade the quality of conversation between the participants.

### BRIEF DESCRIPTION OF THE DRAWINGS

Various embodiments of the invention will hereinafter be described in conjunction with the appended drawings, provided to illustrate and not to limit the invention, wherein like designations denote like elements, and in which:

FIG. 1 is a block diagram illustrating an environment where various embodiments of the present invention may be practiced;

FIG. 2 is block diagram illustrating a system for conducting a conversation in virtual space, in accordance with some embodiments of the present invention;

FIG. 3 is a block diagram illustrating elements of a processing unit, in accordance with some embodiments of the invention;

FIG. 4 is a flowchart illustrating a method for directing attention during a conversation in virtual space, in accordance with some embodiments of the present invention; and

FIG. 5 illustrates a display unit, in accordance with some embodiments of the present invention.

Skilled artisans will appreciate that elements in the figures are illustrated for simplicity and clarity, and have not necessarily been drawn to scale. For example, the dimensions of some of the elements in the figures may be exaggerated relative to other elements, to help in improving an understanding of embodiments of the present invention.

### DETAILED DESCRIPTION OF THE INVENTION

Various embodiments of the invention provide a method and a system for directing attention during a conversation in virtual space. Data streams are received from a plurality of participants of the conversation present in a network. At least one feature of the received data stream is processed, based on which representations of the plurality of participants on a display unit are altered.

Before describing in detail the method and system for directing attention during conversation, it should be observed that the present invention resides primarily in combinations of method steps and system components related to a method and system for directing attention in conversation. Accordingly, the system components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

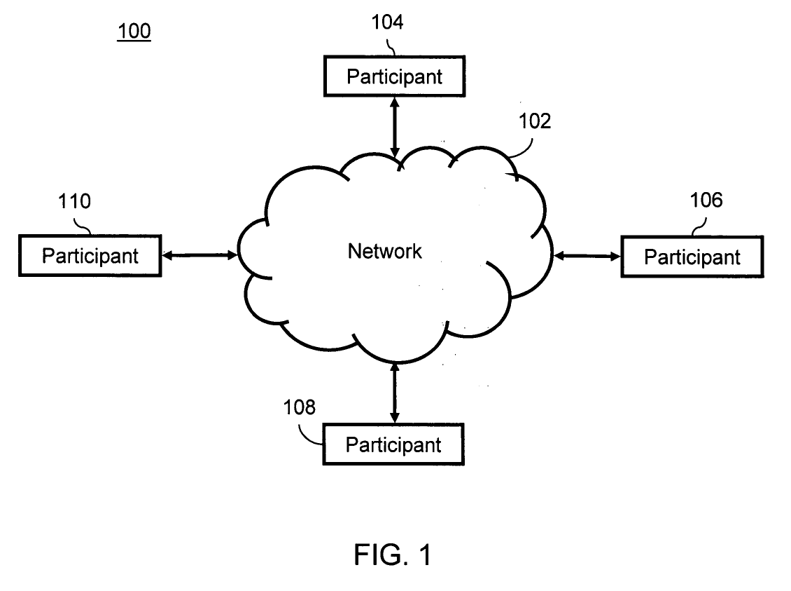

FIG. 1 is a block diagram illustrating an environment 100 where various embodiments of the present invention may be practiced. The environment 100 includes a network 102, a participant 104, a participant 106, a participant 108, and a participant 110. The participants 104, 106, 108 and 110 are hereinafter referred to as a plurality of participants. The plurality of participants can communicate with each other through the network 102. Examples of the network 102 include the Internet, a Public Switched Telephone Network (PSTN), a mobile network, a broadband network, and so forth. In accordance with various embodiments of the invention, the network 102 can also be a combination of the different types of networks.

The plurality of participants communicates by transmitting and receiving data steams across the network 102. Each of the data streams can be an audio data stream, a video stream or an audio-visual data stream, in accordance with various embodiments of the invention.

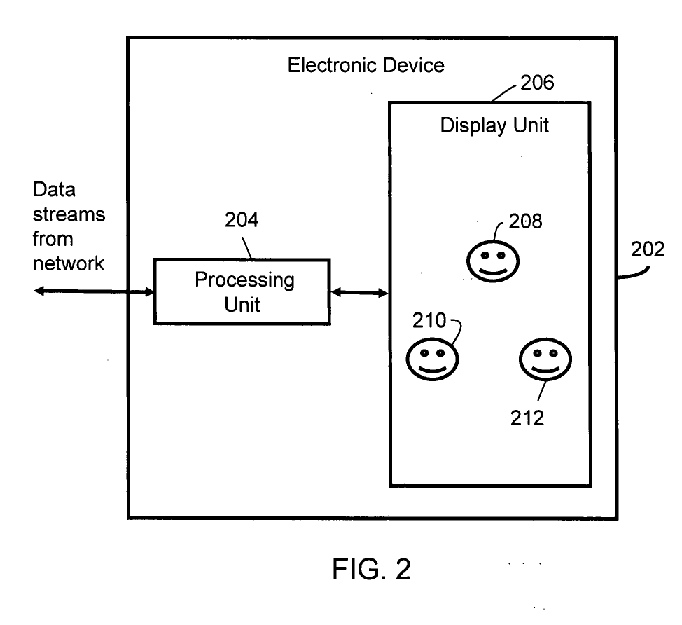

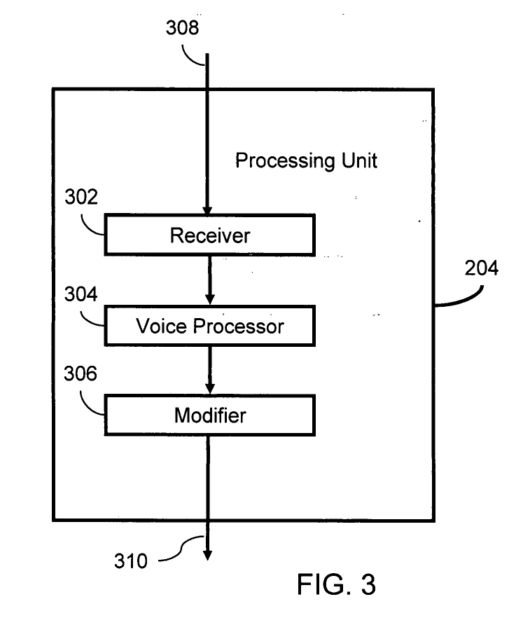

FIG. 2 is block diagram illustrating a system for conducting a conversation in virtual space, in accordance with an embodiment of the present invention. The system may be realized in an electronic device 202, in an embodiment of the invention. Some examples of the electronic device 202 are a computer, a Personal Digital Assistant (PDA), a mobile phone, and so forth. The electronic device 202 includes a processing unit 204 and a display unit 206. In an embodiment of the invention, the processing unit 204 resides outside the electronic device 202. The processing unit 204 processes at least one feature of at least one of the data streams. The processing unit 204 is described in detail in conjunction with FIG. 3. The display unit 206 displays representations of at least one of the plurality of participants. In an embodiment of the invention, the participant 104 has a representation 208, the participant 108 has a representation 210, and the participant 110 has a representation 212. In the embodiment, the participant 106 is communicating with the participants 104, 108 and 110 through the electronic device 202. The representations 208, 210 and 212 may be a video representation or an image representation, for example, a photograph of the participant. In one embodiment, the image representation can be the representation 208 for an audio data stream transmitted by the participant 104. The image representation may be based on a dynamic image alteration or a static image alteration. In some embodiments, a dynamic image alteration is used. For example, a photograph of the person is used, wherein the photograph is dynamically changed without distorting the geometric proportions of the photograph in response to values of the processed feature or features of the data stream conveying the conversation of the person. In other embodiments, a static image alteration is used. For example, a geometric shape or line drawing is used, of which only two examples are a square or a circle, wherein the color of the geometric shape is changed in response to values of the processed feature or features of the data stream conveying the conversation of the person. That is to say a static alteration does not substantially change the size of the representation, whereas a dynamic alteration does change the size, but without distorting the geometric proportions of the representation. These examples are not meant to bind a type of image representation to a type of alteration. For example, a geometric image could alternatively be dynamically altered. A dynamic alteration could alternatively be called a proportional size alteration, and a static alteration could alternatively be called a fixed size alteration.

FIG. 3 is a block diagram illustrating the elements of the processing unit 204, in accordance with an embodiment of the invention. The processing unit 204 includes a receiver 302, a voice processor 304, and a modifier 306. The data streams 308 are received by the receiver 302 from the plurality of participants. The voice processor 304 extracts at least one feature of at least one data stream. Examples of the at least one feature of the data stream include the pitch, the intensity, voicing, waveform correlation and speech recognition of the audio data. In an embodiment of the invention, the data streams are decoded by a decoder before processing the feature. The modifier 306 makes a determination based on at least one of these features of the data stream to alter the size of the representation, the pattern of the representation, the color of the representation or the background color of the representation, as represented by a signal 310 that controls the representation. In some embodiments, the determination is a determination of an emotional state of the participant. This determination may be made using well known techniques based on audio features, or using new techniques based on audio features.

In an embodiment of the invention, the modifier 306 changes the size of the representation, based on the intensity of the data streams. In another embodiment of the invention, the modifier 306 modifies the representation by changing a color of the representation, based on the pitch of the data streams. For example, the color of the representation can be changed from green and red, based on an increase in the pitch of the corresponding data stream. In yet another embodiment, the modifier 306 modifies the representation by changing a background color of the representation, based on at least one feature of the data streams.

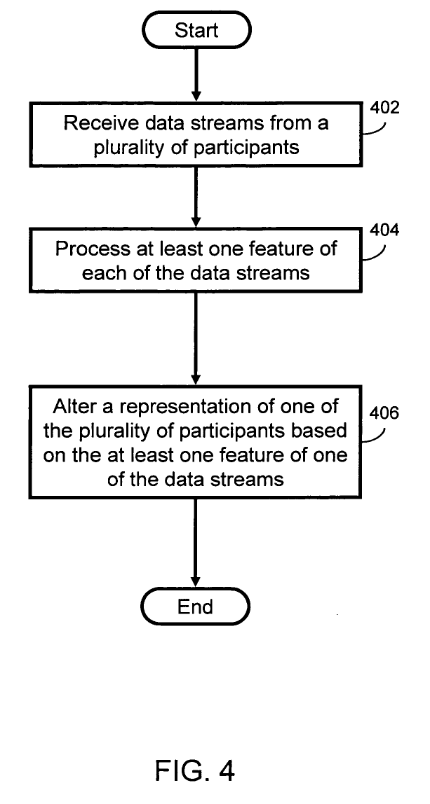

FIG. 4 is a flowchart illustrating a method for directing attention during a conversation in a virtual space, in accordance with an embodiment of the present invention. At step 402, the data streams are received from a plurality of participants, which may be, for example, the plurality described with reference to FIG. 1. At step 404, the data streams are processed to extract at least one feature from at least one data stream from each of the plurality of participants. The extraction is carried out by the processing unit 204, in an embodiment of the invention. Note that these embodiments do not exclude the possibility of one or more additional participants other than the plurality of participants, wherein the additional participants' communications are not enhanced by the benefits of the feature extraction. In various embodiments of the invention, the data streams are decoded by a decoder before processing the at least one feature from each of the plurality of participants. The features of the data stream include, but are not limited to, the pitch, intensity, voicing, waveform correlation, and speech recognition of portions of the audio data. At step 406, a representation of each one of the plurality of participants is altered, based on at least one of the features of their respective data streams. Alteration of the representation is carried out in such a manner that the geometric proportions of the representation are maintained. Altering the representation includes changing at least the size of the representation, the pattern of the representation, the color of the representation, or the background color of the representation. It also includes displaying a modified representation of the participant on the display unit 206.

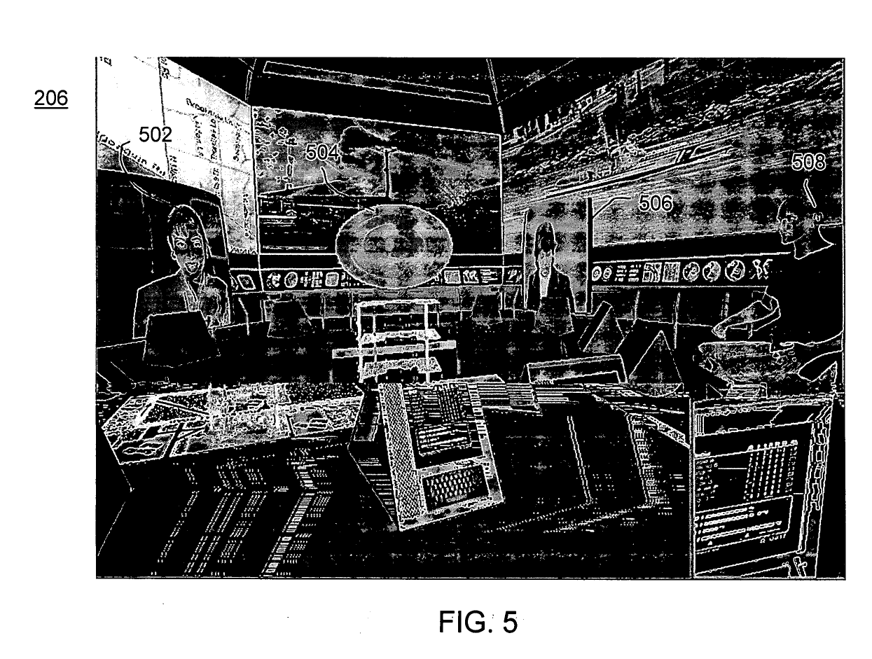

FIG. 5 illustrates the display unit 206, in accordance with an embodiment of the present invention. The display unit 206 displays a representation 502, a representation 504, a representation 506, and a representation 508. The representations 502, 504, 506 and 508 correspond to the plurality of participants in conversation in virtual space. For example, the representations 502, 504, 506 and 508 may correspond to the participants 104, 106, 108 and 110, respectively. In an embodiment, the representation 502 may be a video representation, which may correspond to a video stream being received from the participant 104. The representation 506 may be a photograph of a participant The representation 508 may be a static 3D model representation of an participant 110 that is being statically altered using the audio or audio-visual data stream being received from the participant 110. The representation 504 may be a geometric image representation of an audio stream from the participant 106. The representations 502, 504, 506 and 508 are altered by the modifier 306, based on at least one of the features of one of the data streams, so that the geometric proportions are maintained. The attention of a user using the electronic device 202, is directed due to a change in the representation of at least one of the plurality participants in the display unit 206. For example, when the participant 106 gets angry or speaks loudly, a color of the representation 504 can change from green to red. This may attract attention of the user towards the participant 106. In another example, the participant 108 laughs resulting in vibration of the representation 506, which is a photograph of the participant 108. In another example the video 502 derived from the video stream of the participant 104 is increased in size in response to a determined emotional state or audio level.

Various embodiments of the present invention, as described above, provide a method and a system for directing attention during a conversation in virtual space. This is achieved by altering the representations of a plurality of participants displayed on the display unit. The various embodiments provide a method for making a conversation in a virtual space interesting and more effective by bringing conversational dynamics into play. It will be appreciated that the methods and means for doing this may be quite simple and therefore allow a low cost of implementation.

In the foregoing specification, the invention and its benefits and advantages have been described with reference to specific embodiments. However, one of ordinary skill in the art appreciates that various modifications and changes can be made without departing from the scope of the present invention as set forth in the claims below. For example, a combination of static and dynamic alterations may be useful in some instances. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

A “set” as used herein, means an empty or non-empty set (i.e., for the sets defined herein, comprising at least one member). The term “another”, as used herein, is defined as at least a second or more. The terms “including” and/or “having”, as used herein, are defined as comprising. The term “coupled”, as used herein with reference to electro-optical technology, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system. It is further understood that the use of relational terms, if any, such as first and second, top and bottom, and the like are used solely to distinguish one entity or action from another entity or action without necessarily requiring or implying any actual such relationship or order between such entities or actions.

We claim:

1. A method for directing attention during a conversation in a virtual space, the method comprising:
receiving data streams from a plurality of participants;
processing at least one feature of each of the data streams; and
altering a representation of one of the plurality of participants based on the at least one feature of one of the data streams, such that geometric proportions of the representation are maintained.

2. The method according to claim 1, wherein processing at least one feature of the data streams comprises decoding the data streams.

3. The method according to claim 1, wherein processing at least one feature of the data streams comprises extracting the at least one feature of the data streams.

4. The method according to claim 1, wherein altering the representation comprises changing at least one of: a size of the representation, a pattern of the representation, a color of the representation, and a background color of the representation based on the at least one feature of the data streams.

5. The method according to claim 1, wherein each data stream is one of an audio data stream, a video data stream and an audio-visual data stream at any given time.

6. The method according to claim 5, wherein the feature of the data streams comprises at least one of pitch, intensity, voicing, waveform correlation, and speech recognition of portions of the audio data.

7. A system for conducting a conversation in a virtual space, the system comprising:
a display unit for displaying a representation of at least one of a plurality of participants; and
a processing unit for processing at least one feature of data streams, the data streams being received from the plurality of participants, the processing unit further altering the representation based on the at least one feature of a data stream being received from the participant whom the representation represents.

8. The system according to claim 7, wherein the data streams belong to a group comprising audio data, video data and audio-visual data.

9. The system according to claim 7, wherein the at least one feature of the data streams comprises at least one of pitch, intensity, voicing, waveform correlation, and speech recognition of portions of the data streams.

10. The system according to claim 7, wherein the processing unit comprises a receiver for receiving the data streams from the plurality of participants.

11. The system according to claim 7, wherein the processing unit comprises a decoder for decoding the data streams.

12. The system according to claim 7, wherein the processing unit comprises a voice processor for extracting the at least one feature from the data streams.

13. The system according to claim 7, wherein the processing unit comprises a modifier, the modifier alters at least one of: a size of the representation, a pattern of the representation, a color of the representation, and a background color of the representation based on the at least one feature of the data streams.

14. The system according to claim 13, wherein the modifier alters a size of the representation based on intensity of the data streams.

15. The system according to claim 13, wherein the modifier modifies the representation by altering a color of the representation based on pitch of the data streams.

16. The system according to claim 13, wherein the modifier modifies the representation by altering a background color of the representation based on the at least one feature of the data streams.

17. The system according to claim 7, wherein each representation is altered in at least one of a dynamic manner and a static manner, wherein a dynamic representation alters the size of a representation without altering geometric proportions of the representation, and a static alteration is an alteration that does not substantially change the size of the representation.
